(19) United States
(12) Patent Application Publication
(10) Pub. No.: US 2006/0193217 A1
(43) Pub. Date: Aug. 31, 2006

(54) Optical pickup and optical information reproducing device

(76) Inventors: Hiromitsu Mori, Fujisawa (JP); Kunikazu Ohnishi, Yokosuka (JP); Nobuyuki Maeda, Yokohama (JP); Masayuki Inoue, Yokohama (JP)

Correspondence Address: MCDERMOTT WILL & EMERY LLP, 600 13TH STREET, N.W., WASHINGTON, DC, 20005-3096, US

(21) Appl. No.: 11/302,540

(22) Filed: Dec. 14, 2005

(30) Foreign Application Priority Data
Feb. 28, 2005 (JP) 2005-052245

(51) Int. Cl. G11B 7/00

(52) U.S. Cl. 369/44.23

(57) ABSTRACT

An optical pickup and an optical information recording and reproducing device in which spherical aberration correction control after a disc is loaded can be efficiently made in a short time. Before an information recording medium is loaded into a drive, an optical axis direction position of a concave lens is preset to a state so as to optimize a converging spot on a recording surface of a single-layered medium of as a first recording medium or a predetermined layer (first layer having a substrate thickness of 0.1 mm) of a medium having two or more layers to which the recording/reproduction is executed by a laser light source. After the information recording medium is loaded, if it is determined to be a second (third) recording medium to which the recording/reproduction is executed by a laser light source, setting of the optical axis direction position of the concave lens is changed.

### INCORPORATION BY REFERENCE

The present application claims priority from Japanese application JP2005-052245 filed on Feb. 28, 2005, the content of which is hereby incorporated by reference into this application.

### BACKGROUND OF THE INVENTION

The invention relates to an optical pickup for reproducing or recording information by irradiating a laser beam onto a disk-shaped information medium.

A high density optical disk device using a blue-violet laser having a laser wavelength of a band of 405 nm, an objective lens having a numerical aperture of 0.85, and a BD (Blu-ray Disc) having a substrate thickness of 0.1 mm has been realized as a product. At present, a medium of a single-layered disc and a medium of a double-layered disc exist as BDs. According to the BD standard, in the double-layered disc, there is a difference of the substrate thickness of 25 μm between the first recording layer and the second recording layer. Further, in each recording layer of the double-layered disc or in the single-layered disc, the substrate thickness varies every disc and even in a single disc, the substrate thickness varies in dependence on a recording or reproducing position (in the BD standard, a variation of up to ±5 μm is permitted). If there is such a variation or difference of the substrate thickness as mentioned above, a spherical aberration occurs in a light spot on the disc recording surface and it is difficult to record and reproduce. To correct such a spherical aberration, the optical pickup is equipped with an optical element for spherical aberration correction such as a beam expander. A typical constructional example of such an element has been disclosed in, for example, a Patent Document 1 (JP-A-2002-304763 (pages 21-23, FIGS. 1, 4, and 6)).

As a technique regarding the spherical aberration correction, for example, a technique in which a predetermined correction value of a spherical aberration correcting system is preliminarily stored in a ROM provided for the optical pickup and, upon recording and reproducing of the BD, the correcting system is driven on the basis of the correction value read out of the ROM has been disclosed in, for example, a Patent Document 2 (JP-A-2003-257069 (pages 1-7, FIGS. 1, 2, and 3)).

### SUMMARY OF THE INVENTION

In the optical disk device corresponding to the BD mentioned above, until the disc is loaded, information showing to which one of the single-layered disc and the double-layered disc such a disc corresponds or, even if the disc is the single-layered disc, information indicative of a degree of variation of the substrate thickness cannot be detected on the optical pickup side. When the disc is loaded into the device from such a state, in the optical pickup, there is executed aberration correction control in which a spherical aberration amount due to the substrate thickness error is detected, the optical element for the spherical aberration correction is driven in an optical axis direction from a certain initial position (not determined yet) and moved to a proper position, and the spherical aberration is reduced up to a level at which no trouble is caused in the recording and reproduction. However, in such correction control, there is the following problem: an initial setting position of the optical element for the spherical aberration correction is not preset and it takes time until the proper position of the optical element is searched for, or the aberration correction control fails and the recording and reproduction of the disc cannot be started. Under the condition that the use frequency of the single-layered disc and the first layer of the double-layered disc of the BDs is considered to be highest, solving the above problem is indispensable in order to improve use efficiency of a drive. In consideration of the above problem, it is an object of the invention to provide an optical information recording and reproducing device or an optical information recording device having high use efficiency.

The above object is accomplished by the inventions disclosed in Claims.

According to the invention, the optical information recording and reproducing device or optical information reproducing device having high use efficiency can be provided.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing a construction of an optical pickup in the embodiment 1;

FIGS. 2A to 2C are diagrams for explaining an objective lens 113 in the embodiment 1;

FIGS. 3A and 3B are a diagram and a graph showing an example of a relation between a divergence angle of incident light to the objective lens 113 in the case of a BD medium and a wave front aberration of a converging spot 302 in the embodiment 1;

FIG. 4 is a diagram for explaining a layout and shape parameters of a beam expander element 110 in the embodiment 1;

FIG. 5 is a graph showing a relation between a substrate thickness of the BD medium and an interval between a concave lens 108 and a convex lens 109 which are necessary in the embodiment 1;

FIG. 6 is a graph showing an aberration correcting effect by the beam expander shown in Table 1;

FIG. 7 is a diagram for explaining detecting surfaces of a photodetector 118 and an error signal in the embodiment 1;

FIG. 8 is a diagram showing an example of a construction of a peripheral portion of the beam expander element 110 in the embodiment 1;

FIG. 9 is a flowchart showing an example of an assembling adjusting flow of a BD optical system in the embodiment 1;

FIG. 10 is a flowchart showing an example of a drive operating flow in the case of the BD medium in the embodiment 1;

FIGS. 11A and 11B are graphs showing a focusing error signal in the embodiment 1;

FIGS. 12A and 12B are graphs showing a focusing error signal in the embodiment 1;

FIG. 13 is a flowchart for explaining an operating flow in the case where a focal point is moved from an L0 layer to an L1 layer of the BD medium in the embodiment 1;

FIG. 14 is a flowchart showing an example of an assembling adjusting flow in a DVD optical system and a CD optical system in the embodiment 1;

FIG. 15 is a flowchart showing an example of a drive operating flow in the case of a DVD medium and a CD medium in the embodiment 1;

FIG. 16 is a diagram showing the first example in the embodiment 2;

FIG. 17 is a diagram showing an example of a construction of an optical information recording and reproducing device in the embodiment 3;

FIG. 18 is a diagram showing the second example in the embodiment 2;

FIG. 19 is a diagram showing the third example in the embodiment 2; and

FIG. 20 is a diagram showing the fourth example in the embodiment 2.

### DETAILED DESCRIPTION OF THE EMBODIMENTS

Although the following embodiments are considered as best modes for carrying out the invention, the invention is not limited to the following embodiments so long as the object of the invention is accomplished.

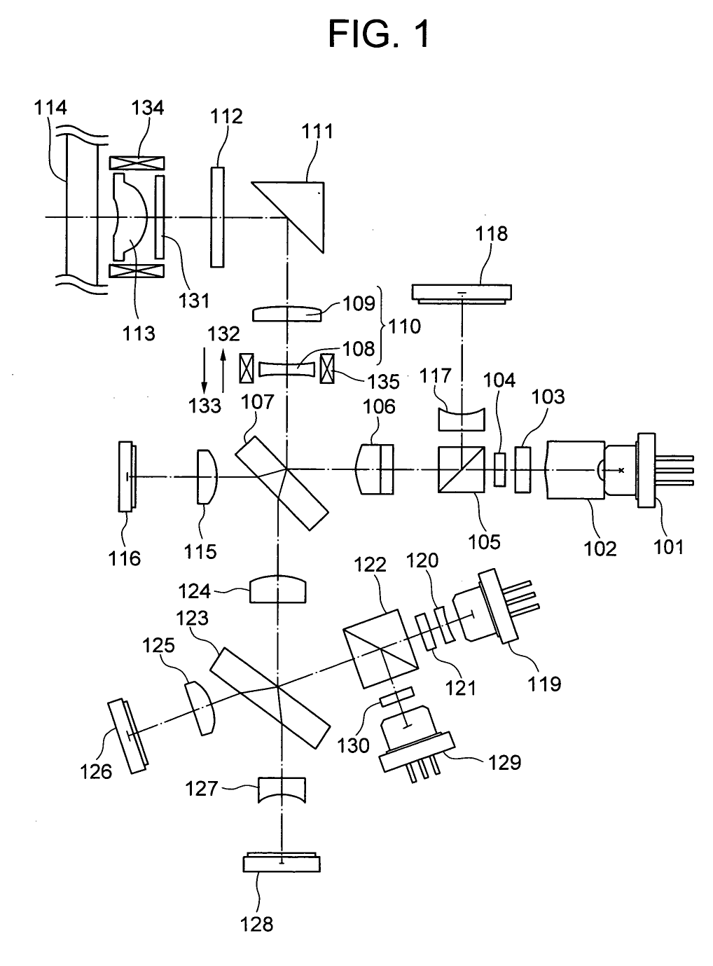

The embodiment 1 will be described hereinbelow. FIG. 1 shows a construction of an optical pickup in the embodiment. It is the optical pickup which can cope with each medium of the BD, DVD, and CD and uses a common objective lens. Light emitted from a blue-violet laser 101 having a wavelength of a band of 405 nm passes through a beam shaping element 102 and a half wave plate 103, is branched into a main beam and two sub beams by a diffraction grating 104 for the BD, and passes through a polarization beam splitter 105. Parallel light is irradiated from a collimator lens 106 for the BD. The parallel light is reflected by a half mirror 107 and passes through a concave lens 108 and a convex lens 109, its beam diameter is enlarged, and the resultant light is reflected by a rising mirror 111. After that, the light is transmitted through a quarter wave plate 112 and an aperture restricting element 131 for the CD, is converged by an objective lens 113, and reaches an information recording surface of an information recording medium 114 (in this case, a BD medium having one, two, or more recording layers). The objective lens 113 and the aperture restricting element 131 for the CD mounted in a common holder (not shown) and parallel movement in the surface oscillating direction and the radial direction of the information recording medium 114 and rotational movement in which the tangential direction of the information recording medium 114 is set to an axis can be executed by an actuator 134. To compensate a spherical aberration which is caused in association with a substrate thickness error of the information recording medium 114, a beam expander element 110 is constructed by a pair of the concave lens 108 and the convex lens 109 and can be moved in the optical axis direction shown by arrows 132 and 133 by an actuator 135. The reflection return light from the information recording medium 114 is transmitted through the objective lens 113 and the quarter wave plate 112, reflected by the rising mirror 111, transmitted through the convex lens 109 and concave lens 108, and reflected by the half mirror 107. After that, the light is transmitted through the collimator lens 106, is reflected by the polarization beam splitter 105, is converged by a detecting lens 117, and reaches a detecting surface of a photodetector 118 for the BD. An RF signal and servo signals (focusing error signal, DPP signal, and the like) are detected by the photodetector 118 for the BD and a spherical aberration error signal is formed on the basis of those signals and detected. A part of the parallel light emitted from the collimator lens 106 for the BD is transmitted through the half mirror 107, is converged by a lens 115, reaches a front monitor 116 for the BD, and a light emission amount of the blue-violet laser 101 is monitored.

Light emitted from a red laser 119 having a laser wavelength of a band of 660 nm is transmitted through an auxiliary collimator lens 120, is branched into a main beam and two sub beams by a diffraction grating 121 for the DVD, and passes through a synthetic prism 122, and thereafter, is reflected by a half mirror 123. Parallel light is irradiated from a collimator lens 124, is transmitted through the half mirror 107, passes through the concave lens 108 and the convex lens 109, its beam diameter is enlarged, and after that, the resultant light is reflected by the rising mirror 111, transmitted through the quarter wave plate 112, converged by the objective lens 113, and reaches the information recording surface of the information recording medium 114 (in this case, the DVD medium having one or two recording layers). The reflection return light from the information recording medium 114 is transmitted through the objective lens 113 and the quarter wave plate 112, reflected by the rising mirror 111, transmitted through the convex lens 109 and concave lens 108, and transmitted through the half mirror 107. After that, the light is converged by the collimator lens 124 and a detecting lens 127, and reaches a detecting surface of a photodetector 128 for the DVD/CD. An RF signal and servo signals (focusing error signal, DPP signal, and the like) are detected by the photodetector 128 for the DVD/CD. A part of the light transmitted through the synthetic prism 122 is transmitted through the half mirror 123, is converged by a lens 125, reaches a front monitor 126 for the DVD/CD, and a light emission amount of the red laser 119 is monitored.

Light emitted from an infrared laser 129 having a laser wavelength of a band of 780 nm is branched into a main beam and two sub beams by a diffraction grating 130 for the CD and is reflected by the synthetic prism 122 and the half mirror 123. The parallel light is irradiated from the collimator lens 124, is transmitted through the half mirror 107, and enters the concave lens 108. The concave lens 108 is moved in the direction shown by the arrow 132. Divergent light is emitted from the convex lens 109. After that, the light is reflected by the rising mirror 111, transmitted through the quarter wave plate 112 and the aperture restricting element 131 for the CD, converged by the objective lens 113, and reaches the information recording surface of the information recording medium 114 (in this case, the CD medium). Since an optical path until the reflection return light from the information recording medium 114 reaches the information recording surface of the photodetector 128 for the DVD/CD is the same as that of the DVD system as mentioned above, its explanation is omitted here. Although the red laser 119 and the infrared laser 129 are separately provided in FIG. 1, a laser of two wavelengths in which those lasers are integrated can be also used in order to simplify the optical system. In dependence on the specifications of the drive, for example, it is possible to use an optical system in which the blue-violet laser 101 and the red laser 119 are mounted without using the infrared laser 129.

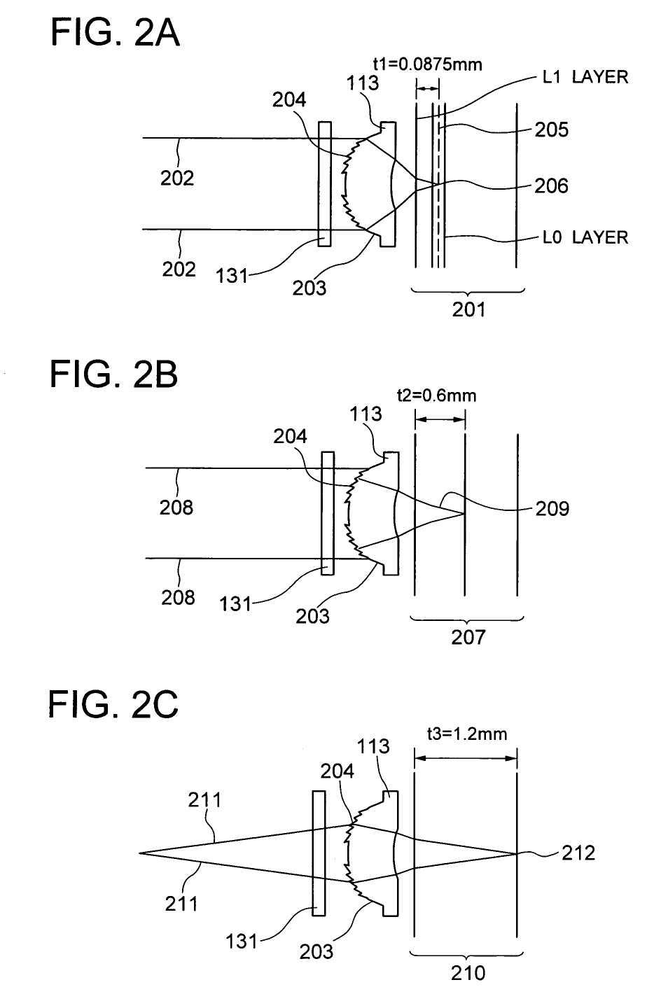

The objective lens 113 will now be described with reference to FIGS. 2A to 2C. FIG. 2A shows the state where the light is converged in a BD double-layers medium 201. Parallel light 202 having the wavelength of the band of 405 nm passes through the aperture restricting element 131 for the CD as it is and is converged by the operation of a refracting plane 203. The objective lens 113 is designed so that a wave front aberration of a converging spot 206 is optimized at a substrate thickness t1 (=0.0875 mm) in an intermediate layer 205 (shown in a broken line portion) comprising an L0 layer having a substrate thickness of 0.1 mm and an L1 layer having a substrate thickness of 0.075 mm. The objective lens 113 is designed so that grating grooves 204 formed concentrically on the refracting plane 203 do not have a diffraction function in such a manner that a numerical aperture of the refracting plane 203 is equal to 0.85 for the light having the wavelength of the band of 405 nm. FIG. 2B shows the state where the light is converged in a DVD medium 207. Parallel light 208 having the wavelength of the band of 660 nm passes through the aperture restricting element 131 for the CD as it is, is diffracted by the grating grooves 204, and is converged by the refracting plane 203. The objective lens 113 is designed so that an aberration of a converging spot 209 is optimized at a substrate thickness t2 (=0.6 mm). The objective lens 113 is designed so that grating grooves 204 are formed in a beam diameter range where the numerical aperture is equal to 0.65 for the light having the wavelength of the band of 660 nm in such a manner that the spherical aberration which is caused due to the wavelength difference of about 255 nm and the substrate thickness difference of about 0.5 mm from those in the case of the BD of FIG. 2A is set off. FIG. 2C shows the state where the light is converged in a CD medium 210. As for divergent light 211 having the wavelength of the band of 780 nm, a beam diameter of the light entering the objective lens 113 is restricted by the aperture restricting element 131 for the CD and the numerical aperture of the objective lens 113 lies within a range from 0.45 to 0.5. The objective lens 113 is designed so that the light is diffracted by the grating grooves 204, converged by the refracting plane 203, and the aberration of the converging spot 212 is optimized at a substrate thickness t3 (=1.2 mm).

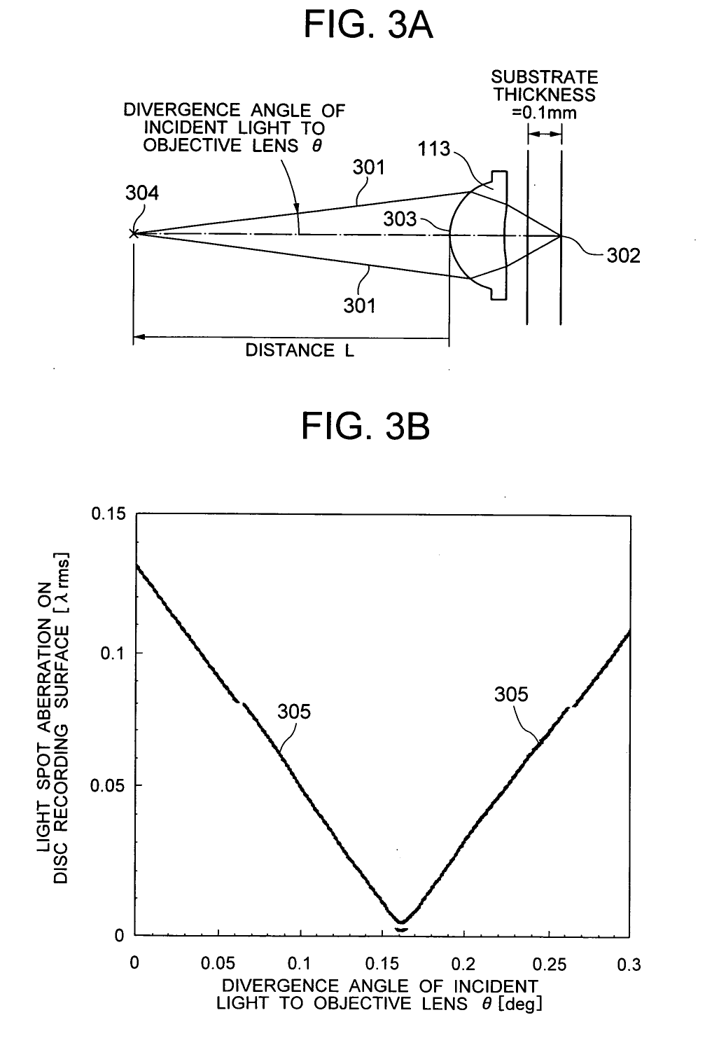

As described in FIG. 2A, in the case of the BD medium, the objective lens 113 is designed so that the wave front aberration of the converging spot 206 is optimized at the substrate thickness t1 (=0.0875 mm). However, it is sufficiently considered that there are two kinds of BD media such as single-layered medium and double-layered medium and both of them are used at present and that at a point when the recording/reproduction of the double-layered medium is started, the use frequency of the L0 layer of the first layer is highest. Therefore, it is necessary to set in such a manner that the wave front aberration of the converging spot becomes minimum at a reference value (=0.1 mm) of the substrate thickness of the single-layered medium and the substrate thickness of the L0 layer of the double-layered medium. For this purpose, as shown in FIG. 3A, it is necessary to allow predetermined divergent light 301 to enter the objective lens 113. FIG. 3B shows an example of calculations executed to find which kind of divergent light should be made to enter in order to minimize a converging spot 302 at the substrate thickness of 0.1 mm. The wavelength is set to 405 nm, the numerical aperture of the objective lens 113 is set to 0.85, the refractive index of the substrate is set to 1.62, a distance L between an incident plane 303 of the objective lens 113 and a virtual light source 304 of the divergent light 301 is changed, and the wave front aberration of the converging spot 302 is calculated. An axis of abscissa indicates a divergence angle θ (°) of the incident light entering the objective lens 113 converted from the distance L. An axis of ordinate indicates a wave front aberration value (λrms) of the converging spot 302. A calculation result is as shown by a curve 305. It will be understood from the result that by setting the divergence angle θ of the incident light to θ=0.16°, the wave front aberration value of the converging spot at the substrate thickness of 0.1 mm can be minimized and this value is suppressed to an enough small value of 0.0027 λrms.

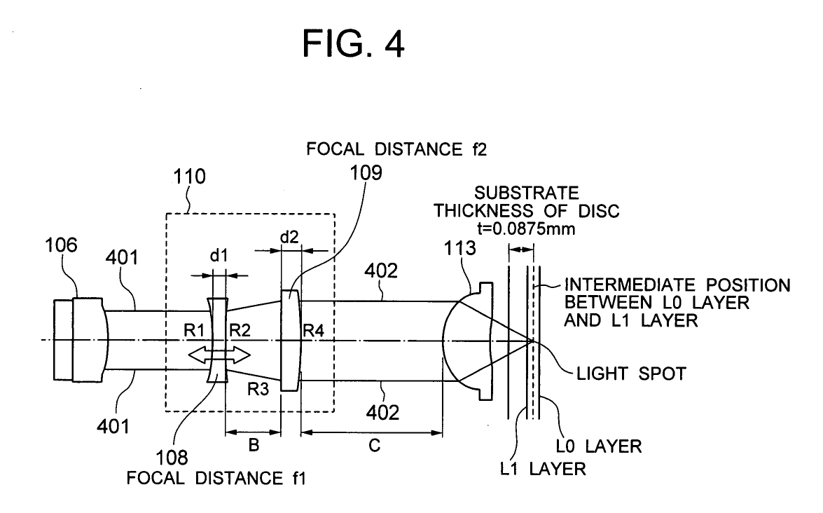

Specific examples of the beam expander element 110 designed on the basis of the result of FIG. 3B will be described hereinbelow. FIG. 4 shows a layout and shape parameters of the concave lens 108 and the convex lens 109 of the beam expander element 110. In this example, in the case of an initial interval B between the concave lens 108 and the convex lens 109, parallel light 401 entering the concave lens 108 is magnified and emitted as parallel light 402 from the convex lens 109. In this example, the convex lens 109 is fixed and when the concave lens 108 is moved in parallel in the optical axis direction from the initial interval B, the divergent light or converging light is emitted from the convex lens 109 and enters the objective lens 113.

TABLE 1

| | Concave lens | Convex lens |
|---|---|---|
| Refractive index | n = 1.60524 | n = 1.60524 |
| Center thickness | d1 = 1.2 mm | d2 = 1.2 mm |
| Focal distance | f1 = −8.225 mm | f2 = 11.225 mm |
| Radius of | R1 = −8.336 mm | R3 = 24.9 mm |
| curvature | R2 = 13.028 mm | R4 = −9.173 mm |
| Aspherical | R1 plane k = 2.25 | R4 plane k = −0.85 |
| constant | | |

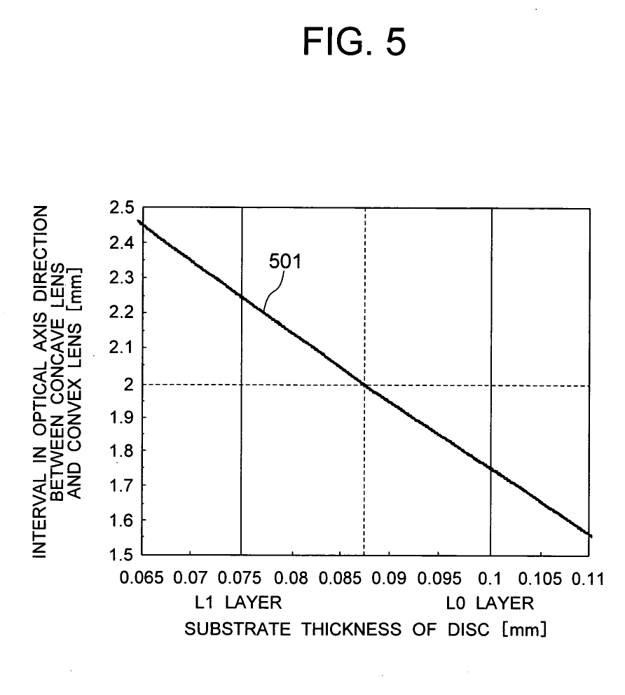

Design values are as shown in Table 1. The initial interval B=2 mm and a distance C between the convex lens 109 and the incident plane of the objective lens is set to (C=15.7 mm). FIG. 5 shows an example of calculations of the interval between the concave lens 108 and the convex lens 109 which are necessary to minimize the wave front aberration of the converging spot when the substrate thickness of the BD medium fluctuates. A straight line 501 shows the calculation result. It will be understood that it is sufficient to set the interval to 1.755 mm, for example, at the substrate thickness of 0.1 mm in the L0 layer.

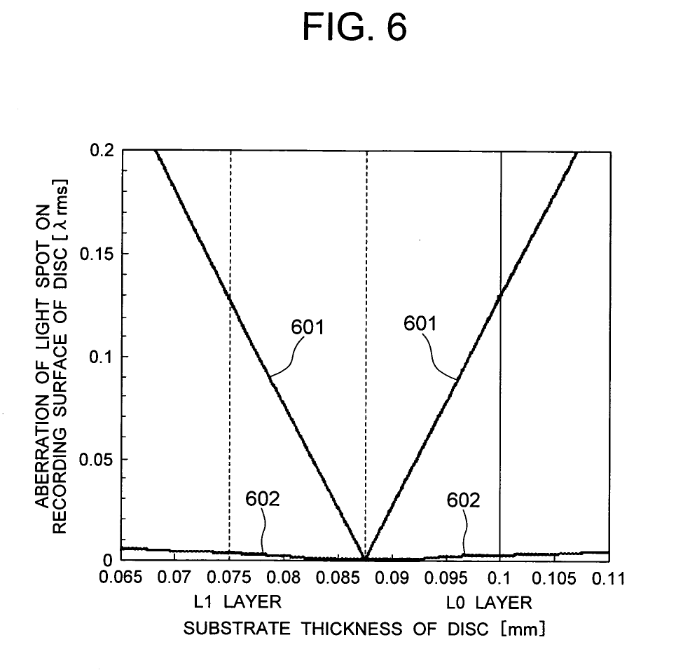

It will be understood that it is sufficient to set the interval to 2.25 mm, for example, at the substrate thickness of 0.075 mm in the L1 layer. Further, the correctable substrate thickness error converted by the movement amount of 1 mm of the concave lens 108 is equal to 0.05 mm. FIG. 6 shows an example of calculations of the substrate thickness of the BD medium and the wave front aberration of the converging spot. A curve 601 shows the case where the aberration correction by the beam expander element 110 is not made. When the substrate thickness is deviated from the design reference value of 0.0875 mm, the wave front aberration of the converging spot deteriorates suddenly. On the other hand, in the case where the aberration correction by the beam expander element 110 is made, the result is as shown by a curve 602. It will be understood that even if the substrate thickness fluctuates by ±0.025 mm from the design reference value of 0.0875 mm, the wave front aberration of the converging spot is suppressed to an enough small value of 0.005 λrms or less.

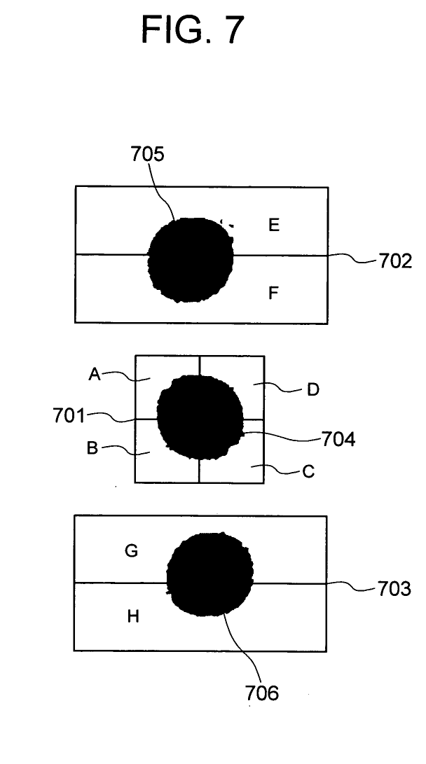

As shown in FIG. 7, in the photodetector 118 for the BD, as photodetecting surfaces, a main detecting surface 701 is formed in the center portion, sub detecting surfaces 702 and 703 are formed in the upper and lower portions, and the photodetector 118 has eight detecting surfaces A to D and E to H. Main light 704 in which the return light from the information recording medium 114 of 0-order light branched by the diffraction grating 104 for the BD has been converged by the detecting lens 117 enters the eight detecting surfaces A to D. Primary light 705 branched by the diffraction grating 104 for the BD enters the eight detecting surfaces E and F. Sub light 706 in which the return light from the information recording medium 114 of -primary light branched has been converged by the detecting lens 117 enters the eight detecting surfaces G and H. An astigmatism method is used for detection of a focusing error. The error signal is obtained by an arithmetic operation of [A+C−(B+D)] and the RF signal is obtained by an arithmetic operation of [A+B+C+D].

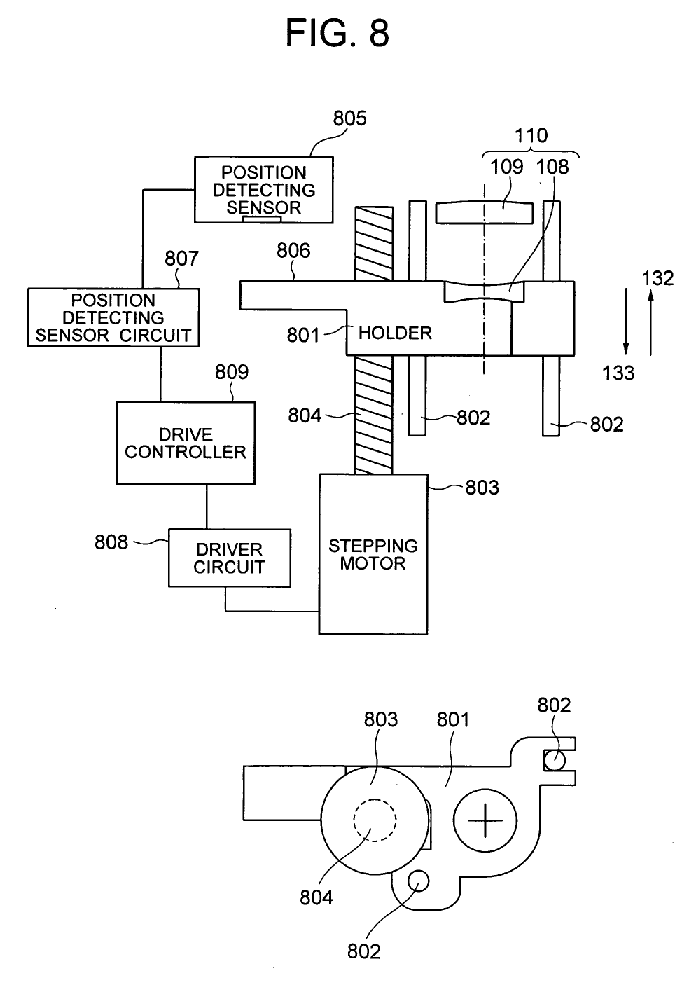

FIG. 8 shows an example of a construction of a peripheral portion of the beam expander element 110. The convex lens 109 is fixed to a frame (not shown) and the concave lens 108 is attached to a holder 801 and supported by guide shafts 802 provided on the right and left sides. The holder 801 is connected to a lead screw 804 of a stepping motor 803 and is moved in parallel in the optical axis direction 132 or 133 by the rotational motion of the lead screw 804. A position detecting sensor 805 to detect the position in the optical axis direction of the holder 801 including the concave lens 108 is attached to the frame (not shown) so as to face the holder 801. Reference numeral 806 denotes a reflecting surface provided for the holder 801. The position detecting sensor 805 is designed so as to have characteristics in which an output voltage linearly changes in accordance with a distance between the position detecting sensor 805 and the reflecting surface 806. Although a contactless reflecting type sensor is used as a position detecting sensor 805 in FIG. 8, it is also possible to use another type such as contactless transmitting type, contact type using a potentiometer, or the like.

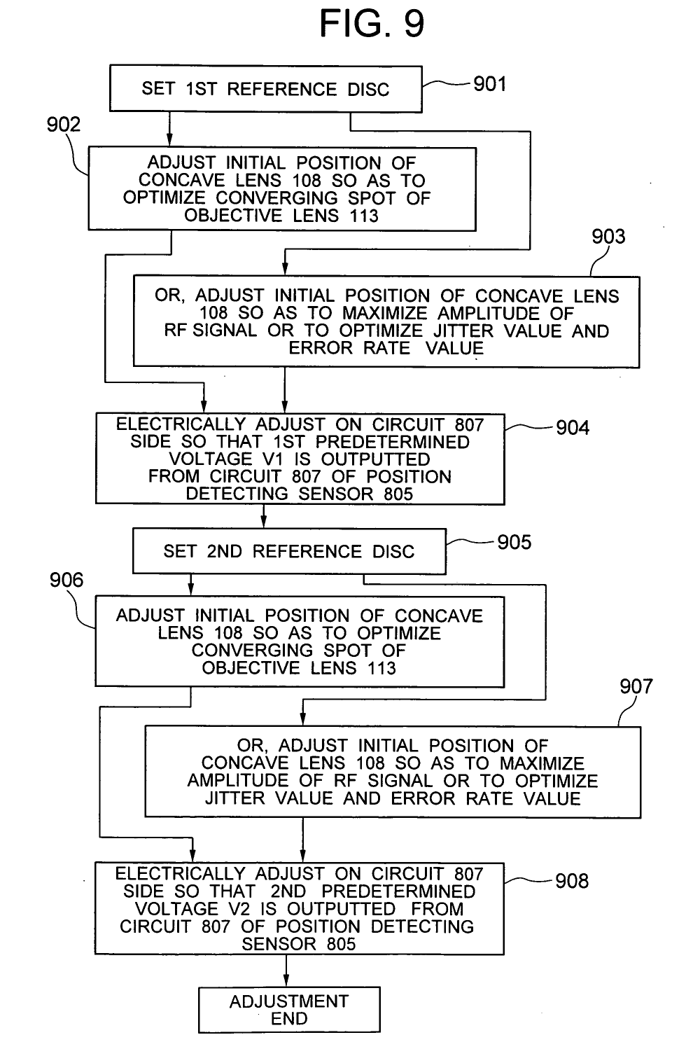

In the embodiment, when the optical pickup is assembled, adjustment is made, for example, in steps 901 to 908 shown in FIG. 9. First, a first reference disc accurately manufactured so that the substrate thickness is set to the same value of 0.1 mm as that of the L0 layer is used, an interferometer, a spot observing apparatus, or the like is used, the stepping motor 803 is driven so that the converging spot obtained by the objective lens 113 enters the optimum state, and the initial position of the concave lens 108 is adjusted. Or, the optical pickup is set into the state where the focusing servo can be performed, the stepping motor 803 is driven so as to maximize an amplitude of the RF signal or optimize a jitter value and an error rate value, and the initial position of the concave lens 108 is adjusted. In this state, electrical adjustment is made on a circuit 807 side of the position detecting sensor 805 so that a first predetermined voltage V1 is outputted from the circuit 807 (for example, the predetermined voltage V1 is recorded into the circuit 807 or the like). Subsequently, a second reference disc accurately manufactured so that the substrate thickness is set to the same value of 0.075 mm as that of the L1 layer is used and the position of the concave lens 108 is adjusted so that the converging spot by the objective lens 113 is set into the optimum state or a jitter value and the error rate value are optimized. After that, electrical adjustment is made on the circuit 807 side so that a second predetermined voltage V2 is outputted from the circuit 807 (for example, the predetermined voltage V2 is recorded into the circuit 807 or the like).

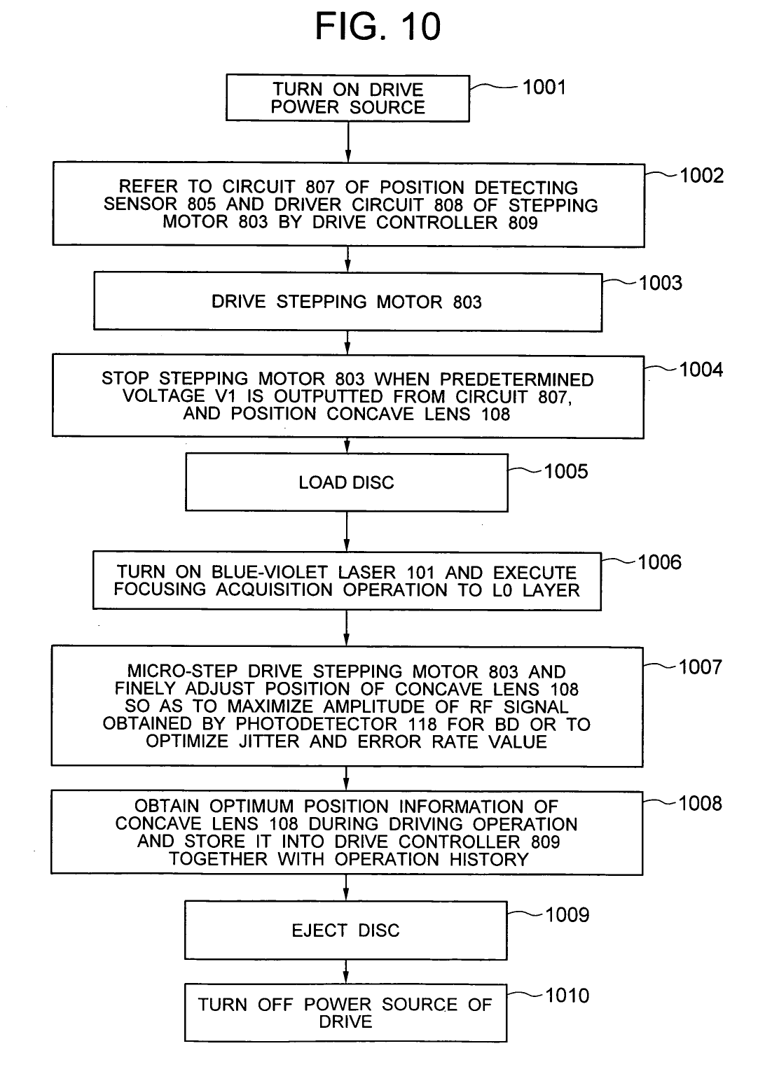

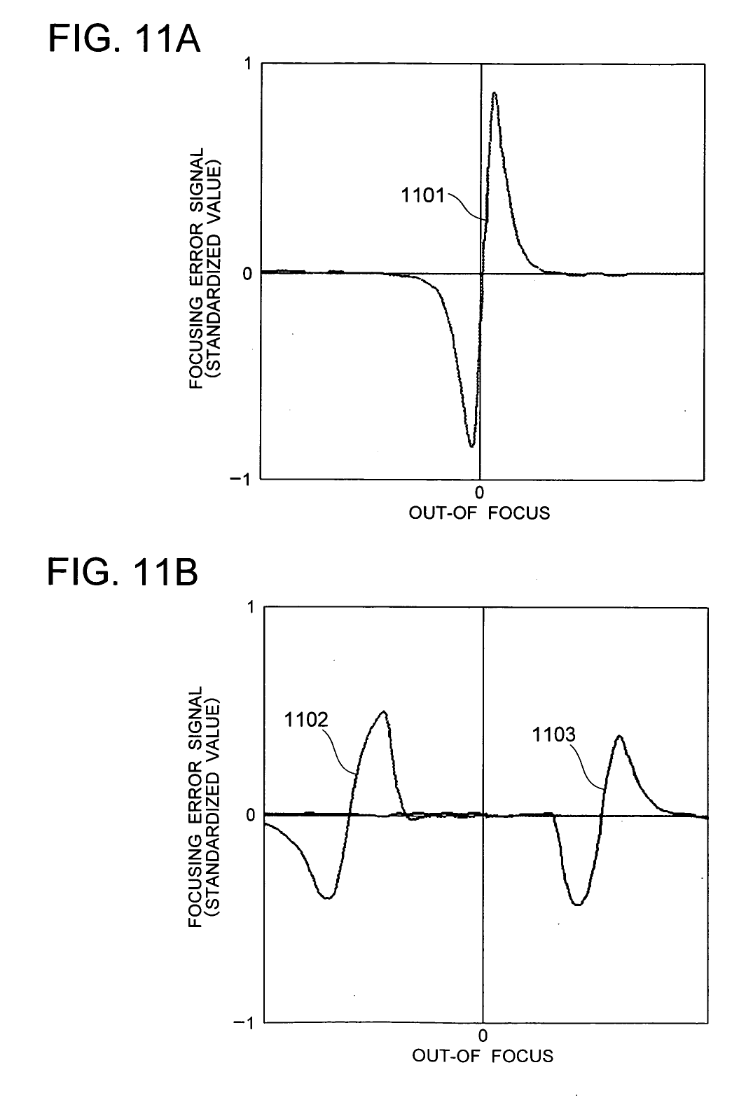

The operation of the drive of the optical pickup adjusted as mentioned above is, for example, as shown in steps 1001 to 1010 in FIG. 10 and will be explained hereinbelow also with reference to FIG. 8. When a power source of the drive is turned on, a drive controller 809 refers to the circuit 807 of the position detecting sensor 805 and a driver circuit 808 of the stepping motor 803. The stepping motor 803 is driven while observing the output voltage from the circuit 807. When the voltage V1 is outputted, the stepping motor 803 is stopped. In this state, the blue-violet laser 101 is turned on and a focusing acquisition is performed to the L0 layer. When the initial position in the optical axis direction of the concave lens 108 is the optimum position, a good S-character curve 1101 is obtained as shown in FIG. 11A. However, when the initial position in the optical axis direction of the concave lens 108 is deviated from the optimum position, the spherical aberration occurs in the light spot on the disc and the light spot cannot be converged. Thus, the focusing error signal deteriorates as shown by as S-character curve 1102 or 1103 in FIG. 11B (the amplitude is decreased and an offset occurs) and there is a risk of failure in the focusing acquisition. To avoid such a situation, the initial position of the concave lens 108 is forcedly determined so that the first predetermined voltage V1 is outputted from the circuit 807 of the position detecting sensor 805 (as described above) before the focusing acquisition is performed to the L0 layer. By this method, the good S-character curve is obtained as shown in FIG. 11A and the focusing acquisition operation can be stably started. Further, actually, since the substrate thickness of the L0 layer has a variation depending on a radial direction position of the disc, there is a possibility of fluctuation of the optimum position of the concave lens 108. For example, while the focusing control is made, the position of the concave lens 108 is finely adjusted so that the amplitude of the RF signal obtained by photodetector 118 for the BD is maximized or the jitter and error rate value are optimized. Such fine adjustment is made, for example, when radial direction position of the disc of the optical pickup is changed. Since information regarding the optimum position of the concave lens 108 is obtained by the driving operation so far, it is stored into the drive controller 809 together with an operation history. When the disc is ejected from the drive and the power source is again turned on from the off state of the power source of the drive, or when the power source is again turned on from the off state of the power source of the drive while the disc is inserted in the drive, the obtained information is immediately transferred to the circuit 807 and the driver circuit 808 from the drive controller 809. By constructing the system as mentioned above, such an effect that the stable driving operation can be executed in a short time and the use efficiency is improved can be obtained.

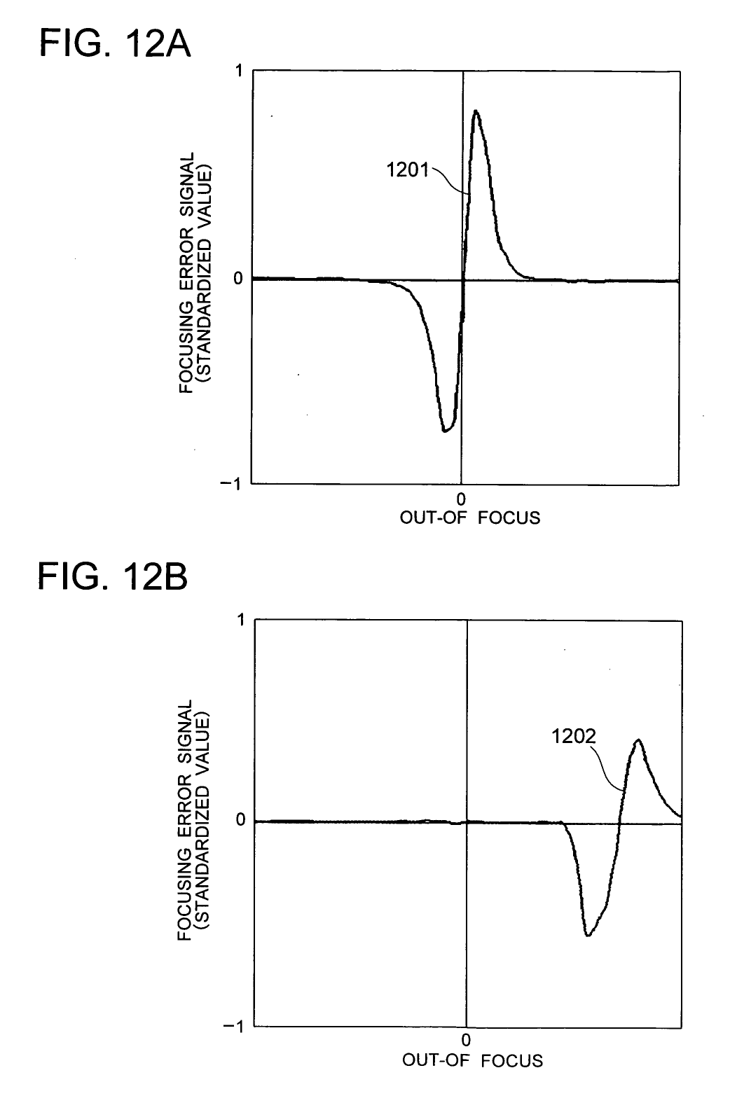

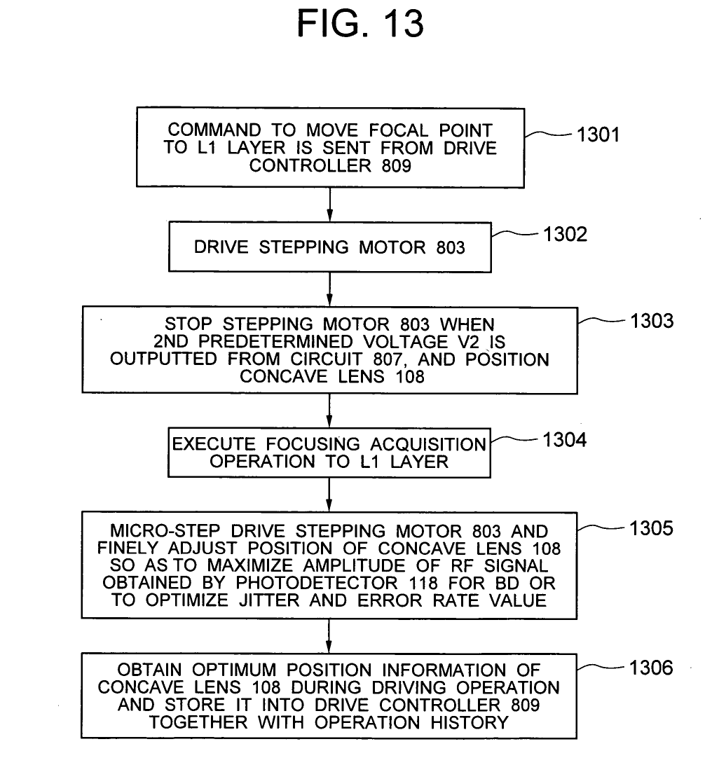

The case of subsequently moving the focal point to the L1 layer from the state where the L0 layer is recorded/reproduced in the double-layered medium will now be described. At this time, the concave lens 108 is located at the optimum position at the substrate thickness of 0.1 mm of the L0 layer. Even if it is intended to move the focal point to the L1 layer in this state, since there is a substrate thickness difference of 0.025 mm between the L1 layer and the L0 layer, the converging spot on the disc is blurred. In this state, the characteristics are as shown by an S-character curve 1202 in FIG. 12B as compared with an S-character curve 1201 in FIG. 12A which is obtained when the focal point is in-focused to the L1 layer and the focusing acquisition cannot be performed, so that there is a risk of failure in the movement of the focal point to the L1 layer. Therefore, the optical pickup is operated, for example, as shown in steps 1301 to 1306 in FIG. 13. When a command to move the focal point to the L1 layer is sent to the optical pickup from the drive controller 809, the position of the concave lens 108 is forcedly moved so that the second predetermined voltage V2 is outputted from the detecting circuit 807 of the position detecting sensor 805 (as described above) before the focusing acquisition is performed to the L1 layer. If the optical pickup is set into such a state, the good converging spot is obtained in the L1 layer, the characteristics are as shown in the S-character curve 1201 shown in FIG. 12A, and the focusing acquisition operation can be stably started. Further, actually, since the substrate thickness of the L1 layer also has a variation depending on the radial direction position of the disc, there is a possibility of fluctuation of the optimum position of the concave lens 108. For example, the position of the concave lens 108 is finely adjusted in a manner similar to the method described before in the operation in the L0 layer. Information regarding the position of the concave lens 108 in the L1 layer obtained by the driving operation so far is stored into the drive controller 809 together with the operation history. When the focal point is again moved to the L1 layer, the obtained information is immediately transferred to the optical pickup from the drive controller 809. In this manner, the focal point can be stably moved to the L1 layer. Since the optimum position information of the concave lens 108 in the L0 layer and the L1 layer were obtained by the driving operation so far, by referring to those information, the stable operation can be executed even in the continuous focal point movement along in the L0 layer→L1 layer→L0 layer. Although the convex lens 109 is fixed and the concave lens 108 is set to be movable in the embodiment, contrarily, it is also possible to fix the concave lens 108 and set the convex lens 109 to be movable.

The case of the BD medium has been described above. A case of the DVD medium and the CD medium will be described hereinbelow. As shown in FIG. 1, the beam expander element 110 is arranged on a common optical path between the red laser 119 having the laser wavelength of the band of 660 nm, the infrared laser 129 having the laser wavelength of the band of 780 nm, and the objective lens 113. Therefore, in the case of recording/reproducing the DVD medium or the CD medium, the position of the concave lens 108 is set to a position different from that in the case of the BD medium. In the case of the DVD medium, since the objective lens 113 is designed as described with reference to FIG. 2B, the initial position of the concave lens 108 is set so that the red parallel light emitted from the collimator lens 124 enters the concave lens 108 and the parallel light from the convex lens 109 is emitted. For example, when a trial calculation is performed by using the expander element shown in Table 1 at the wavelength of 660 nm, it is sufficient to set the concave lens 108 to the position which is away from the convex lens 109 in the optical axis direction by 2.08 mm.

On the other hand, in the case of the CD medium, since the objective lens 113 is designed as described with reference to FIG. 2C, although the infrared parallel light emitted from the collimator lens 124 enters the concave lens 108, the initial position of the concave lens 108 is set so that the predetermined designed divergent light 211 is emitted from the convex lens 109. For example, the objective lens designed so that a virtual light emitting point is located at the position which is away from a principal plane of the objective lens 113 by 90 mm at the wavelength of 780 nm is presumed. When a trial calculation is performed by using such an objective lens and the expander element shown in Table 1, it is sufficient to set the concave lens 108 to the position which is away from the convex lens 109 in the optical axis direction by 0.32 mm.

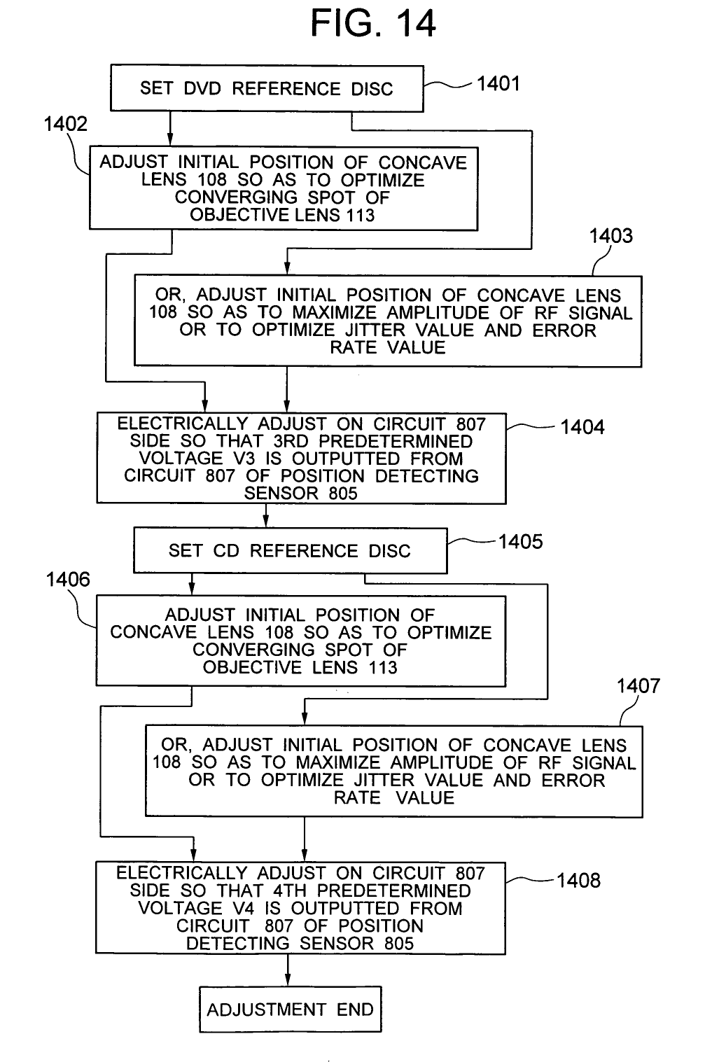

When the optical pickup is assembled, adjustment is made, for example, in steps 1401 to 1408 shown in FIG. 14. First, in the case of the DVD, a DVD reference disc manufactured so that the substrate thickness is set to the same value of 0.6 mm as that of the DVD medium is used, the interferometer, spot observing apparatus, or the like is used, and the initial position of the concave lens 108 is adjusted so that the converging spot by the objective lens 113 enters the optimum state. Or, the optical pickup is set into the state where the focusing servo can be performed and the initial position of the concave lens 108 is adjusted so as to optimize the jitter value and the error rate value. In this state, electrical adjustment is made on the circuit 807 side so that a third predetermined voltage V3 is outputted from the detecting circuit 807 of the position detecting sensor 805. Subsequently, a CD reference disc accurately manufactured so that the substrate thickness is set to the same value of 1.2 mm as that of the CD medium is used and the initial position of the concave lens 108 is adjusted so that the converging spot by the objective lens 113 is set into the optimum state or the jitter value and the error rate value are optimized. In this state, electrical adjustment is made on the circuit 807 side so that a fourth predetermined voltage V4 is outputted from the circuit 807 of the position detecting sensor 805.

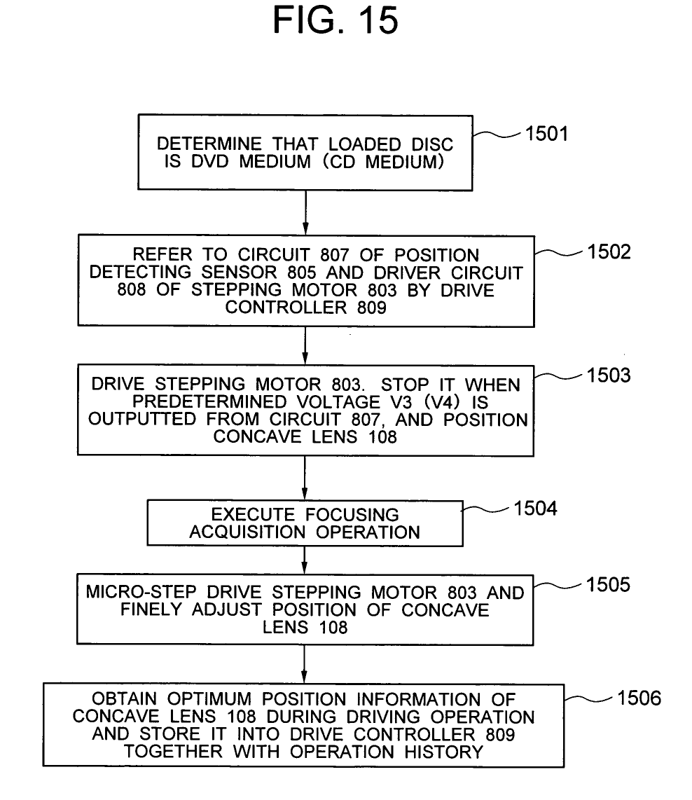

The operation of the drive of the optical pickup adjusted as mentioned above is, for example, as shown in steps 1501 to 1506 in FIG. 15 and will be explained hereinbelow also with reference to FIG. 8. When the disc is loaded into the drive and it is determined that this disc is the DVD medium (CD medium), the drive controller 809 refers to the circuit 807 of the position detecting sensor 805 and the driver circuit 808 of the stepping motor 803. The stepping motor 803 is driven so that the predetermined voltage V3 (V4) is outputted from the circuit 807, thereby deciding the position of the concave lens 108. In this state, the focusing acquisition is performed. When the focusing operation becomes unstable during the operation, the optical axis direction position of the concave lens 108 is finely adjusted. The information regarding the position of the concave lens 108 is obtained by the driving operation so far and stored into the drive controller 809 together with the operation history. When the disc is ejected from the drive and the DVD medium (CD medium) is again used, the obtained information is immediately transferred to the optical pickup from the drive controller (not shown). By constructing the system as mentioned above, such an effect that the stable driving operation can be executed in a short time and the use efficiency is improved can be obtained.

In the embodiment, in the state before the disc is loaded, the state of the optical element for spherical aberration correction is preset so that the converging spot on the disc is optimized at the substrate thickness of 0.1 mm. This substrate thickness of 0.1 mm is a condition in which it is presumed that it is a reference value of the substrate thickness in the single-layered disc and the first layer of the double-layered disc of the BDs and the use frequency is highest. Thus, such a preset state can be set to a start point of the spherical aberration correction and the spherical aberration correction control after the disc was loaded can be most efficiently made.

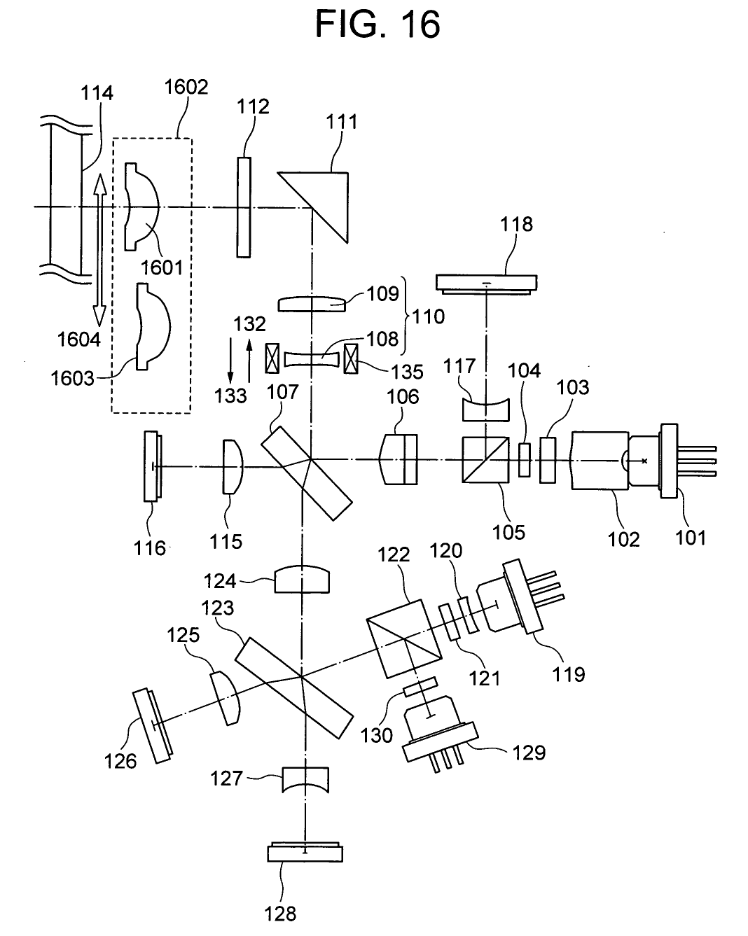

As an embodiment 2, the optical pickup in which two objective lenses of an objective lens for the BD and a DVD/CD-compatible objective lens are mounted and which can cope with each medium of the BD, DVD, and CD will be described. FIG. 16 shows the first example in the embodiment. In this example, an objective lens 1601 for the BD and a DVD/CD compatible objective lens 1603 are mounted on an axial sliding actuator 1602 of a rotary type. The objective lens to be used is switched as shown by arrows 1604 in accordance with a kind of information recording medium 114. The DVD/CD compatible objective lens 1603 is designed so as to optimize the state of the converging spot on the recording surface of the information recording medium 114 when the parallel light enters. For example, when a trial calculation is performed by using the expander element shown in Table 1 at the wavelength of 780 nm, it is sufficient to set the concave lens 108 to the position which is away from the convex lens 109 in the optical axis direction by 2.1 mm. Since an optical system up to the objective lens 1601 for the BD or the DVD/CD compatible objective lens 1603 is common to that in FIG. 1 of the embodiment 1 and has already been described in the embodiment 1, its explanation is omitted here.

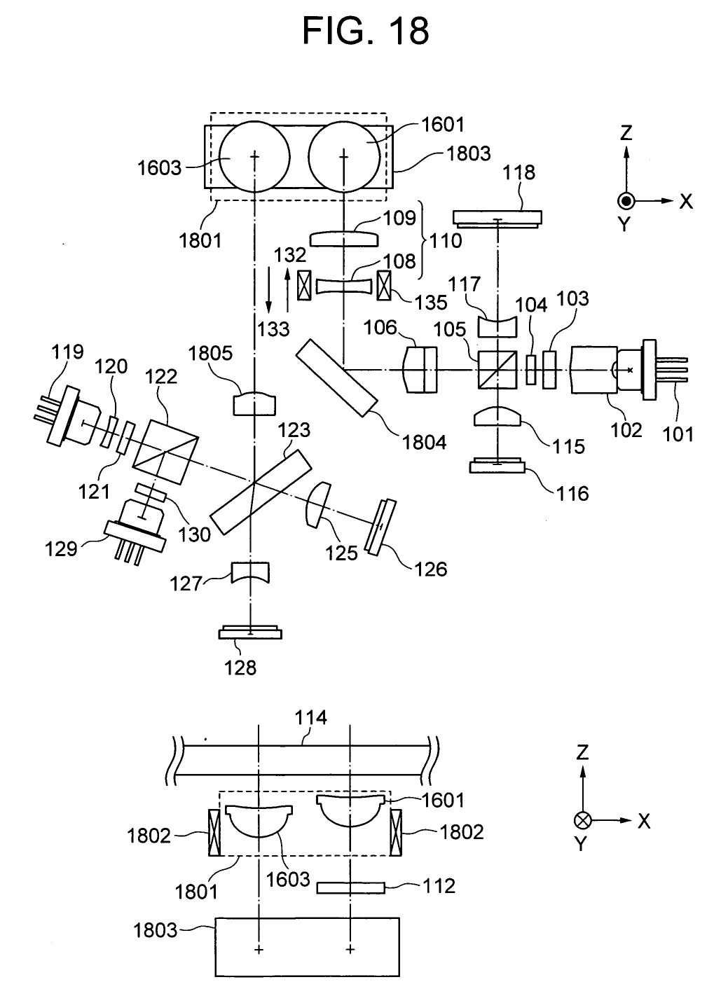

FIG. 18 shows the second example in the embodiment. In the diagram, an X axis, a Y axis, and a Z axis indicate a tangential direction, a radial direction, and a surface oscillating direction of the information recording medium, respectively. The upper stage shows an XY plan view and the lower stage shows an XZ plan view. In this example, the objective lens 1601 for the BD and the DVD/CD compatible objective lens 1603 are arranged in parallel with the X axis and mounted on a lens holder 1801 and a fine translation driving in the Y-axis direction and the Z-axis direction in the diagram and a fine rotational driving around the X axis and the Y axis can be performed by an actuator (not shown) including a driving coil 1802.

The divergent light emitted from the blue-violet laser 101 passes through the polarization beam splitter 105, is converted into the parallel light by the collimator lens 106 for the BD, reflected by a return mirror 1804, transmitted through the beam expander element 110, and reflected by a rising mirror 1803. After that, the light passes through the quarter wave plate 112, is converged by the objective lens 1601 for the BD, and reaches the information recording surface of the information recording medium 114 (in this case, the BD medium having one, two, or more recording layers). A part of the divergent light emitted from the blue-violet laser 101 is reflected by the polarization beam splitter 105, is converged by the lens 115, and reaches the front monitor 116 for the BD, and a light emission amount of the blue-violet laser 101 is monitored. The reflection return light from the information recording medium 114 passes through the objective lens 1601 for the BD and the quarter wave plate 112, reflected by the rising mirror 1803, transmitted through the beam expander element 110, and reflected by the return mirror 1804. After that, the light passes through the collimator lens 106, is reflected by the polarization beam splitter 105, is converged by the detecting lens 117, and reaches a detecting surface of the photodetector 118 for the BD.

After the divergent light emitted from the red laser 119 passes through the synthetic prism 122, it is reflected by the half mirror 123. Parallel light is irradiated from a collimator lens 1805. After that, the resultant light is reflected by the rising mirror 1803, converged by the DVD/CD compatible objective lens 1603, and reaches the information recording surface of the information recording medium 114 (in this case, the DVD medium having one or two recording layers). The reflection return light from the information recording medium 114 passes through the DVD/CD compatible objective lens 1603, is reflected by the rising mirror 1803, and is transmitted through the collimator lens 1805 and the half mirror 123. The light is converged by the detecting lens 127 and reaches the photodetecting surface of the photodetector 128 for the DVD/CD.

The divergent light emitted from the infrared laser 129 having the laser wavelength of the band of 780 nm is reflected by the synthetic prism 122 and the half mirror 123 and the parallel light is emitted from the collimator lens 1805. After that, it is reflected by the rising mirror 1803, is converged by the DVD/CD compatible objective lens 1603, and reaches the information recording surface of the information recording medium 114 (in this case, the CD medium). Since the optical path until the reflection return light from the information recording medium 114 reaches the photodetecting surface of the photodetector 128 for the DVD/CD is substantially the same as that of the DVD optical system of the red laser 119, its description is omitted here.

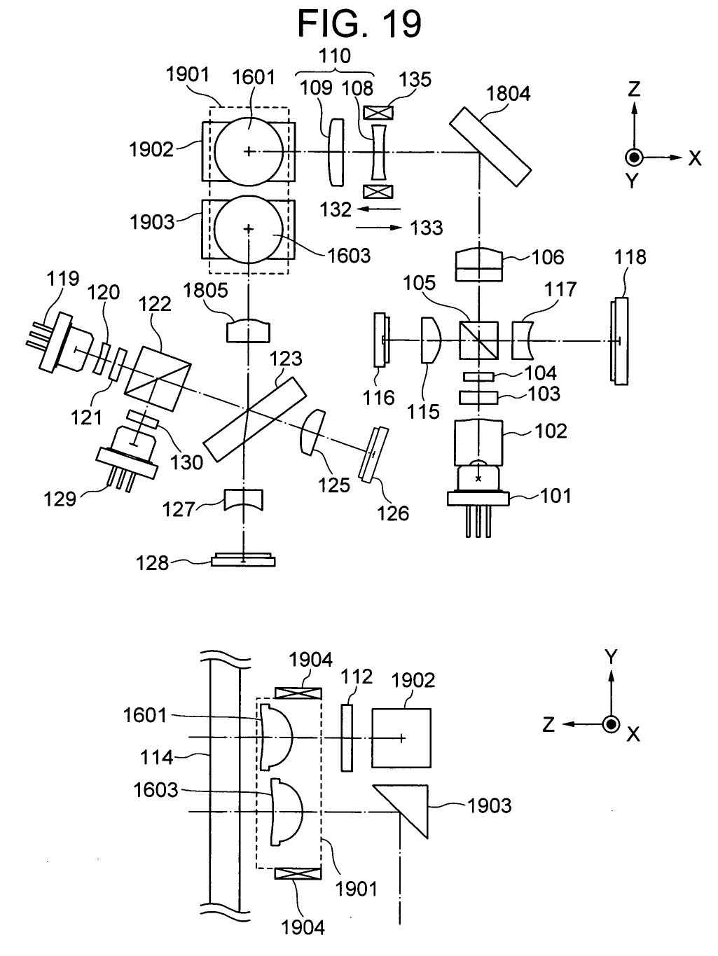

FIG. 19 shows the third example in the embodiment. In the diagram, the X axis, Y axis, and Z axis indicate the tangential direction, radial direction, and surface oscillating direction of the information recording medium, respectively. The upper stage shows an XY plan view and the lower stage shows a YZ plan view. In this example, the objective lens 1601 for the BD and the DVD/CD compatible objective lens 1603 are arranged in parallel with the Y axis and mounted on a lens holder 1901 and a fine translation driving in the Y-axis direction and the Z-axis direction in the diagram and a fine rotational driving around the X axis and the Y axis can be performed by an actuator (not shown) including a driving coil 1904. A rising mirror 1902 for the BD reflects the BD light entering from the −X direction in the diagram and allows it to enter the objective lens 1601 for the BD. A rising mirror 1903 for the DVD/CD reflects the DVD/CD light entering from the Y direction in the diagram and allows it to enter the DVD/CD compatible objective lens 1603. Since the other optical path is substantially the same as that in the second example, its description is omitted here.

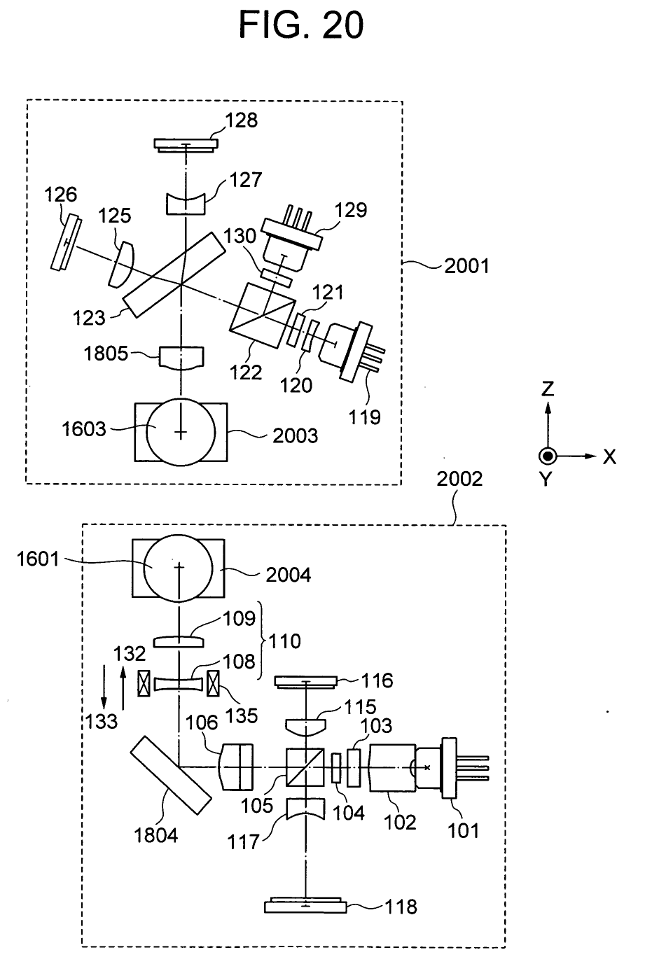

FIG. 20 shows the fourth example in the embodiment. In the diagram, the X axis, Y axis, and Z axis indicate the tangential direction, radial direction, and surface oscillating direction of the information recording medium, respectively. A broken line section 2001 at the upper stage shows the optical pickup for the DVD/CD on which the DVD/CD optical system has been mounted. A broken line section 2002 at the lower stage shows the optical pickup for the BD on which the BD optical system has been mounted. Those optical pickups are enclosed in different pickup casings (not shown).

Although the red laser 119 and the infrared laser 129 are separately provided in FIGS. 16, 18, 19, and 20, a double-wavelength laser in which those lasers are integrated can be used in order to simplify the optical system. For example, an optical system in which the blue-violet laser 101 and the red laser 119 have been mounted without using the infrared laser 129 can be also used in accordance with the specification of the drive.

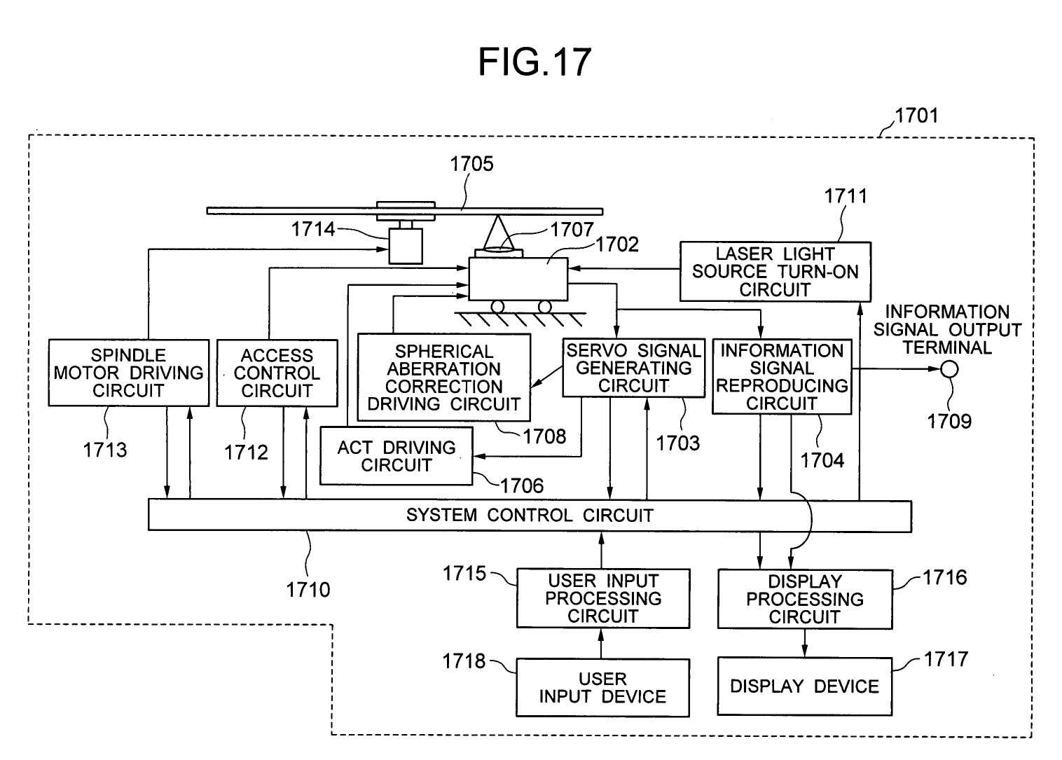

The examples of the optical pickups have been described in the embodiments 1 and 2. An embodiment of an optical information recording and reproducing device on which the foregoing optical pickup has been mounted will now be described. FIG. 17 shows a schematic block diagram of an information recording and reproducing device 1701 for executing reproduction or recording/reproduction of information. Reference numeral 1702 denotes an optical pickup described in the embodiments 1 and 2. A signal detected from the optical pickup 1702 is sent to a servo signal generating circuit 1703 and an information signal reproducing circuit 1704 in a signal processing circuit. In the servo signal generating circuit 1703, a focusing control signal, a tracking control signal, and a spherical aberration detection signal suitable for an optical disk medium 1705 are formed from the signal detected by the optical pickup 1702. On the basis of those signals, an ACT (not shown) in the optical pickup 1702 is driven by an ACT driving circuit 1706, thereby controlling the position of an objective lens 1707. In the servo signal generating circuit 1703, the spherical aberration detection signal is generated from the optical pickup 1702. On the basis of this signal, a correcting lens of a beam expander element (not shown) in the optical pickup 1702 is driven by a spherical aberration correction driving circuit 1708. In the information signal reproducing circuit 1704, an information signal recorded on the optical disk 1705 is reproduced from the signal detected from the optical pickup 1702. The information signal is outputted to an information signal output terminal 1709. A part of the signals obtained by the servo signal generating circuit 1703 and the information signal reproducing circuit 1704 are sent to a system control circuit 1710. A recording signal for laser driving is sent from the system control circuit 1710 and a laser light source turn-on circuit 1711 is driven, thereby controlling the light emission amount and recording the recording signal onto the optical disk 1705 through the optical pickup 1702. An access control circuit 1712 and a spindle motor driving circuit 1713 are connected to the system control circuit 1710 and radial direction position control of the optical pickup 1702 and rotation control of a spindle motor 1714 of the optical disk 1705 are made, respectively. In the case where the user makes control by a personal computer, a recorder for AV, or the like, he gives an instruction to a user input processing circuit 1715 from a user input device 1718 such as keyboard, touch panel, jog dial, or the like, thereby controlling the information recording and reproducing device 1701. At this time, a processing state or the like of the information recording and reproducing device 1701 is processed by a display processing circuit 1716 and displayed by a display device 1717 such as liquid crystal panel, CRT, or the like.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

1. An optical pickup for recording/reproducing information by irradiating a light spot onto an information recording medium, comprising:
a laser light source;
a spherical aberration correcting optical element;
a photodetector; and
an objective lens
wherein said spherical aberration correcting optical element is set so as to optimize a converging spot on a recording surface.

2. An optical pickup for recording/reproducing information by irradiating a light spot onto an information recording medium, comprising:
two or more laser light sources for emitting light having different wavelengths;
an optical element for allowing said light emitted from said laser light sources to be used in common;
a spherical aberration correcting optical element arranged on a common optical path of the light emitted from said laser light sources; and
an objective lens which can converge each of the light emitted from said laser light sources,
wherein said spherical aberration correcting optical element is set so as to optimize a converging spot on a recording surface of a predetermined layer of said information recording medium to which the recording/reproduction is executed by using a predetermined one of the light having the different wavelengths before said information recording medium is loaded.

3. An optical pickup according to claim 2, wherein said information recording medium is a multilayer medium, and
said predetermined layer is a first layer and has a substrate thickness of 0.1 mm.

4. An optical pickup according to claim 2, wherein
said objective lens is set so as to optimize the converging spot at an intermediate position between a first layer and a second layer of a double-layered disc medium when parallel light enters, and
said spherical aberration correcting optical element is set so as to allow predetermined divergent light to enter said objective lens before said information recording medium is loaded.

5. An optical pickup for recording/reproducing information by irradiating a light spot onto an information recording medium, comprising:
two or more laser light sources for emitting light having a wavelength λ1 and a wavelength λ2 or a wavelength λ3;
an optical element for allowing said light emitted from said laser light sources to be used in common;
a spherical aberration correcting optical element arranged on a common optical path of the light emitted from said laser light sources; and
an objective lens which can converge each of the light emitted from said laser light sources,
wherein said objective lens is set so as to optimize a converging spot at an intermediate position between a first layer and a second layer of a double-layered disc medium as a first information recording medium to which the recording/reproduction is executed by using the light having said wavelength λ1 when parallel light having the wavelength λ1 enters,
said objective lens is set so as to optimize a converging spot on a recording surface of a second information recording medium to which the recording/reproduction is executed by using the light having said wavelength λ2 when parallel light having the wavelength λ2 enters,
said objective lens is set so as to optimize a converging spot on a recording surface of a third information recording medium to which the recording/reproduction is executed by using the light having said wavelength λ3 when divergent light having the wavelength λ3 enters, and
said spherical aberration correcting optical element is set so as to allow the divergent light to enter said objective lens at said wavelength λ1 before said information recording medium is loaded.

6. An optical pickup according to claim 2, wherein a state of said spherical aberration correcting optical element adapted to optimize the converging spot on the recording surface of said information recording medium is adjusted by electrical means.

7. An optical pickup according to claim 2, wherein
in case that said information recording medium is a multilayer disc medium,
in the case where a focal point of the converging spot is moved from a first layer to a second layer in said information recording medium or in the case where the focal point of the converging spot is moved from the second layer to the first layer, before a focusing acquisition operation is executed to the second layer or the first layer, setting of the state of said spherical aberration correcting optical element is changed to the state adapted to optimize the converging spot on a recording surface of said second layer or said first layer.

8. An optical pickup according to claim 1, wherein after said information recording medium is loaded, the state of said spherical aberration correcting optical element is set so as to allow predetermined divergent light or converging light to enter said objective lens.

9. An optical pickup according to claim 2, wherein after said information recording medium is loaded, the state of said spherical aberration correcting optical element is set so as to allow predetermined divergent light or converging light having a wavelength λ1 to enter said objective lens.

10. An optical pickup according to claim 5, wherein after said information recording medium is loaded, if it is determined that said medium is said second or third information recording medium, the state of said spherical aberration correcting optical element is set so as to optimize the converging spot on a recording surface of said second or third information recording medium.

11. An optical information reproducing device having a drive equipped with the optical pickup according to claim 1, wherein
for a period of time until an ejecting command of said information recording medium is issued and said information recording medium is actually ejected or for a period of time until a power source of said drive is turned off, optimal state information of said spherical aberration correcting optical element obtained during the operation of said drive is stored into a control circuit of said drive.

12. An optical information reproducing device according to claim 11, wherein
said control circuit is referred to simultaneously with the turn-on of the power source of said drive and for a period of time until said information recording medium is loaded, the optimal state information of said spherical aberration correcting optical element obtained by the previous driving operation is fed back to said optical pickup.

13. An adjusting method of an optical pickup using a first reference disc having a substrate thickness of 0.1 mm and a second reference disc having a substrate thickness of 0.075 mm, comprising the steps of:
adjusting an initial position of a concave lens so that an aberration value of a converging spot to said first reference disc indicates the minimum;
adjusting so that a first predetermined voltage adapted to adjust said initial position is outputted;
adjusting the initial position of the concave lens so that a converging spot to said second reference disc is set to an optimum state; and
adjusting so that a second predetermined voltage adapted to adjust said initial position is outputted,
wherein when said optical pickup is made operative, an initial position of the concave lens is adjusted since said first predetermined voltage or said second predetermined voltage is outputted, thereby adjusting said optical pickup.
